(19) United States
(12) Patent Application Publication
(10) Pub. No.: US 2012/0143694 A1
(43) Pub. Date: Jun. 7, 2012

(54) USING BEHAVIORAL DATA TO MANAGE COMPUTER SERVICES

(75) Inventors: Kamran Rajabi Zargahi, Seattle, WA (US); John Bruno, Snoqualmie, WA (US); Miller T. Abel, Mercer Island, WA (US); Joseph Futty, Sammamish, WA (US)

(73) Assignee: Microsoft Corporation, Redmond, WA (US)

(21) Appl. No.: 12/960,267

(22) Filed: Dec. 3, 2010

(51) Int. Cl. G06Q 30/00; G06N 5/02

(52) U.S. Cl. 705/14.66; 706/46; 705/1.1

(57) ABSTRACT

Some implementations provide techniques for managing features provided by a computer service. A service side framework may receive usage data relating to an application executed on a client device. One or more behavioral algorithms may be implemented to perform behavioral analysis on the received usage data to identify at least one behavioral trend associated with the application. At least one feature of the computer service may be modified based on at least some of the behavioral analysis performed on the usage data. In some implementations, location data may also be taken into consideration.

### BACKGROUND

Software applications are a rapidly developing segment of the consumer marketplace. For instance, applications may be purchased online via web-based marketplace catalogs, often hosted within application stores. Application stores typically allow users to search for, purchase, download and install applications on their computing devices. More advanced application stores also provide options for making ranking and user commentary for the applications available in the marketplace catalog. For example, applications may be ranked according to various criteria, such as the number of downloads, user reviews, and the like. Thus, users can use one or more of keyword searching, category searching, ranking data, and user reviews to discover new applications to download and install on their computing devices.

Application stores and marketplace catalogs allow a single point of entry for users to locate new applications. Large marketplace catalogs currently host tens or hundreds of thousands of applications and are expected to keep growing. Many applications are designed to run on portable or mobile computing devices, such as smartphones, tablet computing devices, netbooks and other Internet-connected mobile devices.

The growth in popularity of devices able to run applications, such as mobile computing devices, has created a flood of new applications competing for visibility in application marketplace catalogs. Due to the large number of applications entering the marketplace, application discoverability has been reduced. It is not unusual for an application to be difficult for a user to discover despite excellent commentary and rankings. Consequently, the dramatic increase in the number of available applications has resulted in a downward pricing cycle for applications. For example, software developers often lower the prices of their applications or offer free versions to attempt to boost visibility, ranking, etc., in hopes of increasing the number of their applications that are sold. Additionally, for consumers, finding relevant applications can be difficult because price may no longer necessarily reflect the true relative value of an application.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide techniques for determining application usage and user behavior, and for applying collected behavioral information to manage features of a computer service. For example, user behavior data may be used by a computer service to improve discoverability of applications in a marketplace. Further, some implementations create competitive criteria for applications to be elevated in a marketplace in a seamless manner based on user behavior.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 illustrates an example operational architecture for obtaining and using behavioral data according to some implementations.

FIG. 2 is a flow diagram of an example process for managing a computer service based on behavioral data according to some implementations.

FIG. 3 is a flow diagram of an example process for managing a computer service based on location data and behavioral data according to some implementations.

FIG. 4 is a diagram of an example hardware environment for obtaining and using behavioral data according to some implementations.

FIG. 5 is a block diagram of an example architecture for a computer service that utilizes behavioral data according to some implementations.

FIG. 6 is a flow diagram of an example process for managing one or more features of a computer service based on behavioral data according to some implementations.

FIG. 7 is a block diagram of an example client device and environment according to some implementations.

FIG. 8 is a block diagram of an example service computing device and environment according to some implementations.

### DETAILED DESCRIPTION

### Behavioral Data Collection and Use

The technologies described herein generally relate to determining and applying behavioral data. For example, users and application developers typically do not have access to behavioral data related to applications. As a result, a particular user may have difficulty discovering applications that support application behavioral patterns that best meet the particular user's needs. For example, a first user might use an application in a first manner in a particular situation or location, while a second user might use the application in an entirely different manner, or might use an entirely different application. Thus, the two users might have different behavioral patterns with respect to similar situations, locations, etc. Further, application developers may have difficulty in discerning application features that might be adopted to address the needs of underserved behavioral patterns. Additionally, application developers currently do not have the ability to change application attributes in marketplace catalogs based on behavioral data, such as for increasing rankings or increasing the likelihood of purchase of an application.

Some implementations herein use behavioral data to improve or elevate discoverability of one or more applications. For example, methods and systems herein may include behavior-based application services. Implementations herein may include, but are not limited to, collecting application usage data on a client device, aggregating the collected usage data, and determining one or more behavioral trends from the collected usage data. For instance, the collected usage data may be analyzed to determine behavior data and applied to various services, such as for providing recommendations and advertising services based upon the behavioral analysis of the collected usage data.

In some implementations, behavioral data relating to how a user behaves or interacts with an application or computing device may be obtained with user consent. The behavioral data may be used to modify one or more features of a computer service. In some implementations, the one or more features of the computer service may be modified to elevate the discoverability of one or more applications, such as for surfacing the application with respect to an individual, a particular group, or the general public. For example, a first user may install an application on his or her computing device and permit the application to provide application usage data to the computer service for determining behavioral data. The behavioral data may then be used for the benefit of the first user. Furthermore, the first user may choose to share the behavioral data and/or the usage data with friends. For example, the usage data may include the number of launches of an application, length of use of the application, location of use of the application, number of interactions with the application (e.g., number of pages or cells viewed, number of items opened or used, number of clicks, etc., depending on the type of application), and the like. Further, usage data of a plurality of users may be aggregated to leverage the wisdom of the crowd for elevating applications.

In some implementations, behavioral data with respect to an application may be determined by analyzing usage data obtained from the user's computing device. Usage data might include statistics as to which applications are most downloaded, or which applications are most used. However, usage data can be contrasted with behavioral data which describes how a user interacts with an application or reacts within a given context. For instance, because commentary and ranking data does not differentiate application feedback from users with different behavioral patterns, an application's commentary and ranking may in fact be different than if screened according to a behavioral model. For example, a power user may find a particular text editing application under-featured and give the application negative feedback. In contrast, a casual user may provide the same application with a high ranking for not having a large number of confusing or unnecessary features. Currently, marketplace catalogs and application stores are not able to provide users with an ability to search for applications via behavioral patterns, and are not able to surface applications to application purchasers based on behavioral data. Thus, implementations herein may aggregate data for a user, may aggregate data across a plurality of users, and/or may aggregate data across applications. For example, the collected information may be used to improve the visibility of applications determined to be a suitable match for particular users, groups of users, or classes of users. Implementations may also provide behavior-based feedback on applications to application developers. For example, the behavioral data aggregated across a particular application may be applied by the developer of that application to enable tailoring of the particular application so as to make the particular application more useful or attractive to certain users, certain groups of users, an identified class of users, or all potential users. As another example, the behavioral data aggregated across a particular application may be provided to a competing application developer to enable the competing developer to develop a superior competing application based on the behavioral data e.g., an application that does not contain features determined to be undesirable, or an application that further develops or expands features determined to be most desirable.

As mentioned above, users may consent to having their usage data tracked and reported to a computer service. According to some implementations, the usage behavior may be tracked even while a user's computing device is offline. For example, a computing device having an application installed may not have constant network access, may be in a power-saving or airplane mode, or otherwise not able to communicate with the computer service. However, the computing device may continue to collect usage data locally and can forward the aggregated usage data at a later time when network communication is available or permitted. Additionally, in some implementations, with user consent, the usage data and/or behavior data may also be shared (e.g., anonymously) with the application developer to enable the application developer to make improvements to the application. Thus, the usage data and/or behavior data of an individual may be aggregated with the data of other users for providing behavioral data with respect to the application, a particular group of users, a general class of users, or the like. Additionally, in some implementations, machine learning may be applied to the processing of the collected data to improve the efficiency and direction of the data analysis. For example, machine learning may be applied to the collected data, such as for detecting behavioral patterns and trends among certain users, classes of users, types of applications, or the like.

Some implementations herein provide techniques for integrating behavior data as a characteristic in application discovery and application store organization. For example, usage data may be collected over time, and periodically reported to the cloud, a computer service, an application store, or the like. Additionally, according to some implementations, the collected usage data can be analyzed and used to modify the marketplace or one or more other features of a computer service. For example, the collected usage data can be used to determine actual user behavior with respect to an application and may provide a user with personalized recommendations based on the behavior of the user and/or the user's friends. As one example, the marketplace is able to surface new catalog pivots such as: “Most popular apps of the day,” “People near you are using these apps,” or “Your friends used these apps when they were here,” for dynamically promoting applications that are actively used. This allows the user to benefit not just from the recommendations of friends, but also from the actual active usage behavior of the user's friends.

Furthermore, implementations may also enable the application itself to be dynamically modified in response to detected user behavior. For example, the user behavior data may indicate that the particular user is proficient in performing certain functions while not proficient in performing other functions. This determination of the user's proficiency may be made based on the user's interaction with the particular application, or based on the user's interaction with one or more other applications. In light of this determination, the application may be modified to present a user interface that enables the user to interact using functions with which the user is most proficient. For instance, suppose that a particular application requests that the user enter a large number of data points. In an unmodified version of the application, the application may present a wizard interface that enables an average user to enter the large number of data points. However, based on behavioral data collected either from the user's interaction with the particular application or from the user's interactions with other unrelated applications, the computer service or the application itself may determine that the particular user does not require the wizard interface and may be considered an expert user who is able to more efficiently enter the data points without the use of the wizard using a different style interface. Based on this determination, the particular application can dynamically change or transform into a different mode, format, or version to present a different user interface such as a single entry form suitable for users who are classified as experts based on their behavioral data. For example, the application itself may receive behavioral data from the computer server and make this determination. Alternatively, the computer service may make the determination and send instructions to the application to dynamically change the application.

In addition, different versions of an application may be initially surfaced or recommended to different users based on the behavioral data determined for those users. Thus, based on a behavioral data regarding a first user's interaction with one or more other applications that the first user already has, the computer service might recommend or cause to surface a first version of a new application that is suitable to the detected behavioral patterns of the first user. On the other hand, for a second user having different detected behavioral patterns, the computer service might recommend or cause to be surfaced a second version of the application that is more suitable to the detected behavioral patterns of the second user, based upon the second user's interactions with one or more other applications that the second user already has. Thus, each user has a version of the application that is suitable for the user based on behavioral data deter determined for the user.

As mentioned above, behavioral data collected from multiple users can be aggregated (e.g., anonymously) across one or more applications and applied to various different uses. In some implementations, the aggregated behavioral data of multiple users can be used for determining which version or mode of several different versions or modes of an application is most effective or useful. For example, suppose an application developer has developed a first version of an application having a first set of features and a second version of the application having a second set of features, different from the first. The developer may compare aggregated behavioral data collected from users using the first version of the application and with aggregated behavioral data collected from users using the second version of the application. For example, the developer may establish one or more criteria for determining whether the first version or the second version of the application is more successful. Examples of suitable criterion might include determining which features of the application are used most often by the users, which features in a particular set of features are used to interact with each other, how often the application is used, the length of time that the application is used, or the like.

As another example, the behavioral data aggregated across an application may also be employed for identifying particular features or attributes of an application that users find useful. The application developers may then explore expanding on or improving the particular features or attributes that users find most useful, e.g., those features used most frequently. In addition, the aggregated behavioral data may indicate that a particular first group or class of users tends to use a first feature of an application, while a second group or class of users tends to use a second feature of the application. Based on this, the computer service might cause a first version of the application having an expanded or augmented first feature to be surfaced to the first group or class of users, while a second version of the application having an expanded or augmented second feature might be surfaced to the second group or class of users.

Additionally, some implementations may monitor and collect location-specific usage data and behavior data. For example, the location specific usage data may relate to a user, a user's friends, a particular group, or the general public. Obtaining location-specific usage data involves sensing a location of a computing device when a particular activity is occurring. For example, a particular application may be initialized and/or used on the computing device at a particular location or the application may be used in a particular manner at the particular location. In some implementations, the user may be notified when an application is heavily used in the particular location (e.g., the application is used more frequently at the particular location than at other locations, is used more frequently than any other application at the particular location, and the like). For example, when the user arrives at an identified location, the computer service or an application on the computing device may inform the user that the particular application is most often used at the identified location or used in a particular manner at the identified location. Additionally, during usage data collection, there may be times when the computing device does not have an active location detection system (e.g., the computing device may lack a location detection system or the location detection system may simply be turned off or inactive). In this case, the computing device may use other means for determining an approximate location, such as by storing information regarding available cell towers, available Wi-Fi access points, and the like, with the usage data. The approximate location of the computing device corresponding to the collected usage data may be determined subsequently in the cloud when the usage data and the cell tower or access point information is transferred.

Other context data, in addition to or alternatively to location data, may also be collected and applied to determine the behavioral data. For example, the time of day, other applications running on the user's device, other applications frozen in the background, the user's calendar information, environmental information, such as current weather conditions, whether the user is moving or stationary, or other context information may be collected with the application usage data and provided for analysis. Thus, any of various types of data may be used to determine a current context in which a user is using an application. For instance, location data may indicate that a user is at work, but the time of day may indicate that the user is on a lunch break, while a heart-rate monitoring application running on the computing device may indicate that the user is exercising during the lunch break. Thus the manner in which a user is using an application on the computing device might differ dramatically in various contexts during regular working hours, such as depending on whether the user is waiting in line for coffee, in the elevator, or at his or her desk.

As another example, context may be based in part on whether the user is in a “normal” location that the user normally frequents during a daily routine, or in a “non-normal” location, such as a location that the user has never been before or travels to very infrequently. Further, normal locations may be segregated into various types or classes of locations that the user frequents such as work, gym, home, coffee shops, favorite restaurants, grocery stores, and the like. The classes of locations may further be delineated such as a first type of restaurant vs. a second type of restaurant in the favorite restaurants class. For example, the user may use a particular application in a first way in a sports bar type restaurant and may use the particular application in a second way or in combination with a second application in a fast food type restaurant.

Additionally, users themselves may be classified based on the collected usage data for one or more applications. For example, collected usage data for a particular user may indicate that the user should be classified in a class of users that often uses social networking, a class of users that are frequent news readers, etc. The classifications can then be applied when a particular user is searching for an application. For example, the computer service may identify one or more classes to which the particular user belongs. Based on this identification, the computer service may surface to the user during the search a first application or group of applications suitable for the one or more classes, rather than a second application or group of applications suitable for different classes.

In some implementations, the performance of the application on the computing device of the user may be tracked and recorded as part of the usage data. For example, if an application is performing poorly or a running slowly on the user's computing device, the user's pattern of behavior with respect to the application may be significantly different than if the application is running or performing well. The performance of the application may be monitored and recorded with respect to the execution time used for carrying out one or more functions, the time required to respond to user interactions with the application, the percentage of CPU processing capacity used by the application, the percentage of memory capacity used by the application, or the like. Thus, the performance of the application may be taken into consideration in combination with other user behaviors with respect to the application.

In addition, according to some implementations, the usage data may be tracked and collected on the computing device as a background process, and the collected usage data may be periodically provided to the computer service as a batch update. Users may have the option of sharing their usage statistics with friends or the public, or may keep the information private for personal use. Further, certain applications may provide incentives for users to share their usage data such as in exchange for gaining access to other people's usage data. As another example, the sharing of the usage data may be required by the application provider in return for the user being permitted to download the application at a reduced price. Accordingly, some implementations herein are directed to a combination of a device-centric tracking framework and a cloud-based behavioral analysis component that correlates user behavior within an application, such as to promote placement of the application within the marketplace and/or dynamic advertising delivery. Thus, implementations provide increased visibility of applications based on actual user usage and behavior.

### Example Operational Architecture

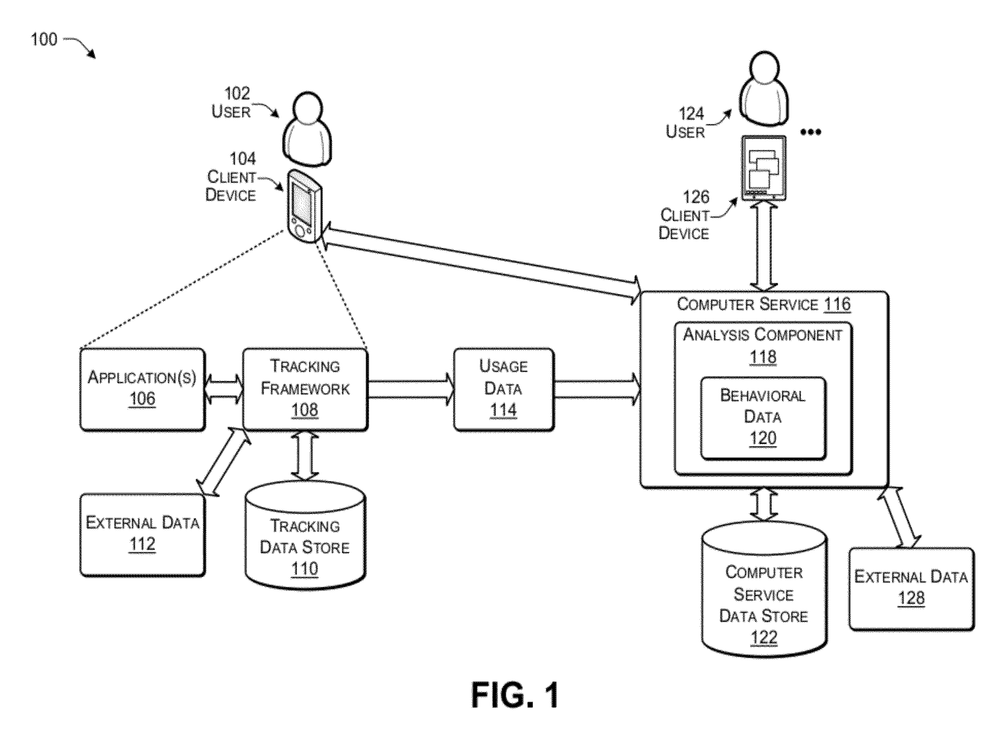

FIG. 1 illustrates an example operational architecture 100 for enabling behavior-based computer services. In the illustrated example, a user 102 uses a client device 104 having one or more applications 106, a tracking framework 108 and a tracking data store 110. Client device 104, and the other client devices discussed herein, may broadly include any device that can run a software application. For example, client device 104 may include, but is not limited to, mobile devices such as smart phones, net books, tablet computing devices, ebook readers, laptops, notebooks, and other mobile computing devices. Client device 104 also may include non-mobile devices such as personal computers and other devices having computing capability.

Client device 104 may include an operating system (not shown in FIG. 1) and may execute one or more applications 106. Further, client device 104 may execute client side tracking framework 108 locally. In some implementations, tracking framework 108 may be a separate application or application interface installed on the client device 104, while in other implementations, the tracking framework 108 may be part of a particular application 106 installed on the client device 104. Other variations will also be apparent in view of the disclosure herein. When an application or operating system function executes on client device 104, the tracking framework 108 may monitor and the record the occurrence in the tracking data store 110. Note that because an operating system may arbitrate activity between different applications 106, cross application behavioral usage data may also be collected. Accordingly, as described above, numerous types of usage data may be collected with respect to one or more applications and or the operating system as they are used on the client device 104. The usage data may include, for example, user interactions with an application, interactions between various applications, functions performed by each application, the performance of each application, determining any applications running concurrently or frozen in the background, and the like.

The tracking framework 108 may contemporaneously collect non-application data such as external data 112. External data 112 may include but is not limited to personal data and social network data such as data from a user's Facebook®, Twitter® or LinkedIn® account. External data 112 may also include context data such as environmental information, location data and other types of context data, as described above. For example, tracking framework 108 may record a time and location at which a particular application function was utilized, other detected activities such as movement of the client device, current air temperature, altitude, and other environmental parameters. Tracking framework 108 may also detect other applications 106 being used concurrently on the client device 104, frozen in the background, r recently used, etc.

The information collected by tracking framework 108 may be referred to as usage data 114. The client side tracking framework 108 may aggregate usage data 114 locally in the tracking data store 110 and upload the usage data 114 as a batch. Alternatively or additionally, tracking framework 108 may persistently upload usage data 114 to a computer service 116 for remote aggregation as the usage data 114 is collected. For example, client device 104 may be configured to communicate with the computer service 116 through any of various communication technologies including both wireless and wired technologies. Suitable wireless technologies may include cellular telephone protocols including, but not limited to, Cell Division Multiple Access (CDMA), Time Division Multiple Access (TDMA), Frequency Division Multiple Access (FDMA), Groupe Special Mobile (GSM), or their successors. Alternatively, both wired and wireless IEEE 802 standards (e.g. Ethernet or Wi-Fi) may be used to communicate with the computer service 116.

The locally executing client side tracking framework 108 monitors usage behavior related to one or more applications 106. For example, the tracking framework 108 may monitor usage with respect to a particular application 106, or with respect to several or all of the applications 106 that are installed on the client device 104. A suitable user interface may be provided with tracking framework 108 to enable the user to opt in to having the usage data collected for one or more of the applications 106. The usage data 114 is provided by the tracking framework 108 to the computer service 116, where the usage data 114 is aggregated and analyzed by an analysis component 118 to determine behavioral data 120.

Upon determining the behavioral data 120, the computer service 116 may utilize the behavioral data 122 modify one or more features of the computer service 116. For example, user 102 may desire to locate an application for a particular purpose. The user 102 may access computer service 116, which can then use the behavioral data 124 of the user 102 to determine from a computer service data store 122 a suitable application for the user 102 based on the behavioral data 120. Accordingly, rather than merely providing a ranked list of applications, such as might be determined from popularity with the general public, the computer service may use the behavioral data 122 to provide the user 102 with specific recommendations based on the behavioral data 122.

Additionally, with the permission of user 102, other users may also obtain the benefit of the behavioral data 120 when accessing the computer service 116. For example, suppose that a second user 124 is a friend of the user 102 such as may be determined from a social networking site, a buddy list, or other affiliation information. When the second user 124 uses his or her client device 126 to access the computer service 116, the computer service may use of the behavioral data 120 of user 102 to determine one or more features to present to the user 124. For example, in the case in which the second user 124 wishes to locate an application for a particular use, the computer service 116 may recommend a corresponding application that the behavioral data 120 indicates that the first user 102 uses most often for the particular use. Thus, some implementations herein rely on the underlying assumption that users that are friends in a social network, or the like, tend to have behavioral patterns that are more similar to each other than to the general public.

Furthermore, with the permission of the user 102, the behavioral data 120 may be aggregated with behavioral data obtained from other users having similar behavior patterns or characteristics. For example, suppose that the user is a member of a group on a social network site. Based on this knowledge, the analysis component 118 may aggregate the behavioral data of the user 102 with behavioral data from other members of the particular group. Thus, when other members of the particular group are searching for applications, their membership in the group may be taken into consideration by the computer service when surfacing one or more applications in response to the search.

As mentioned above, the computer service 116 performs behavioral analysis on aggregated usage data from client device 104 using the analysis component 118. The aggregated usage data 114 from client device 104 may be supplemented with external data 128 including, but not limited to, idealized statistical models and marketplace data. The behavioral analysis may provide trend analysis, pricing analysis, advertising analysis, marketing analysis, and the like. In some implementations, the behavioral analysis may include machine learning to fine tune the analysis of the collected usage data for identifying behavioral trends and patterns.

In some implementations, examples of computer services that may be implemented using the operational architecture 100 include application stores and marketplace catalogs. For example, a behavior-aware marketplace catalog may be implemented that allows users to search based on behaviors. The computer service may also allow application developers to increase the likelihood of their application being purchase based on behavioral data, for instance, by improving an application's ranking and visibility. Furthermore, the behavior-aware marketplace catalog may affirmatively surface applications to potential purchasers based on behavioral analysis. Accordingly, typical users of computer service 116 may include, but are not limited to application developers, application product planners, and application purchasers.

### Example Process Based on Behavior Data

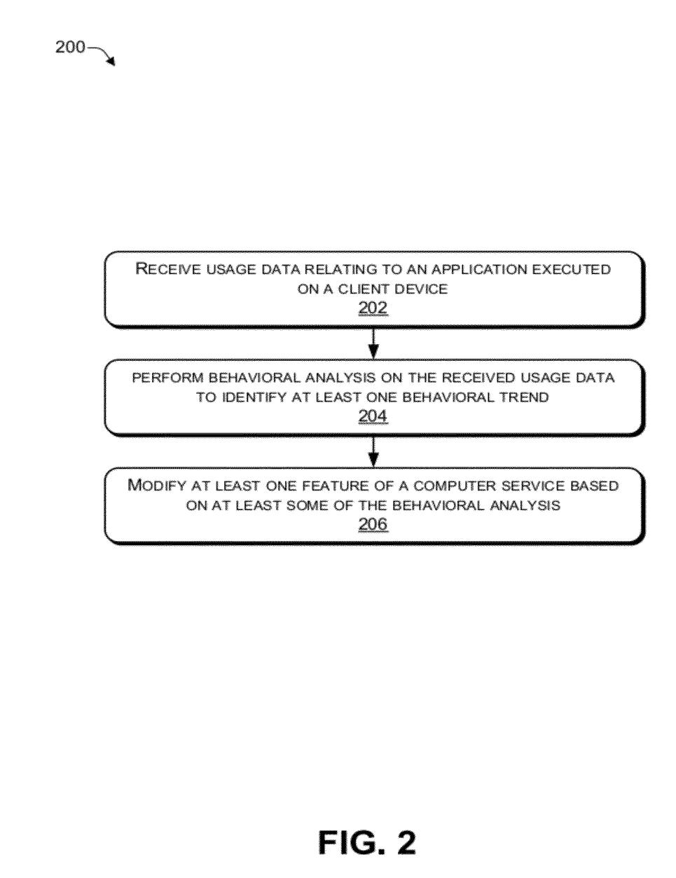

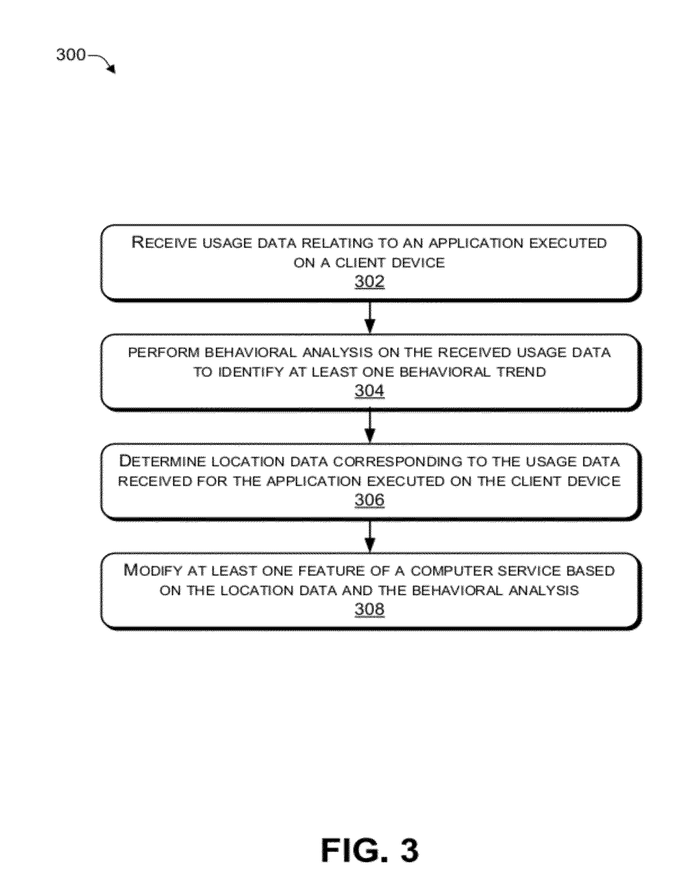

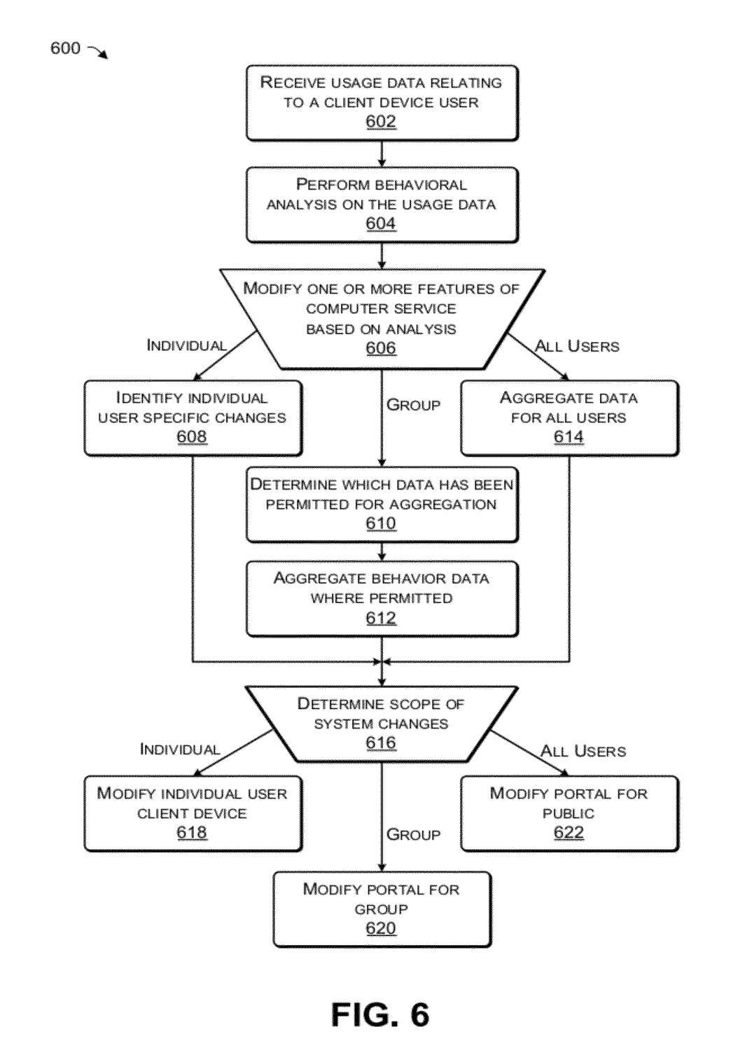

FIG. 2 is a flow diagram of an example process 200 for modifying a feature of a computer service based on behavior data according to some implementations herein. In the flow diagram of FIG. 2, and in the flow diagrams of FIGS. 3 and 6, discussed below, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 200 is described with reference to the operational architecture 100 of FIG. 1, and may be performed by one or more computing devices that implement the computer service 116. However, other frameworks, devices, systems and environments may also implement this process.

At block 202, usage data relating to an application executed on a client device is received. For example, computer service 116 may receive usage data 114 from client device 104. The usage data 114 may relate directly or indirectly to the use of one or more applications 106 that are executed on the client device. For example, in some implementations, the received usage data may include an identity of a user of the client device, the identity of an application function executed on the client device, or a context in which the application function is executed. Further, the received usage data may be associated with a group of a plurality of users that share an affiliation, such as a group of friends, a social network group, a buddy list, or the like. This can enable sharing of behavior data among the associated users of the group.

At block 204, behavioral analysis is performed on the received usage data to identify at least one behavioral trend. For example, behavior analysis component 118 may be implemented by the computer service 116, and can analyze the received usage data 114 for detecting one or more behavioral trends of the user 102 of the client device 104. In some implementations, the behavior analysis component may utilize a behavioral algorithm as described further below. The one or more behavioral trends may be stored as behavioral data 120.

At block 206, at least one feature of the computer service may be modified based on at least some of the behavioral analysis. For example, the computer service 116 may use of the behavioral analysis results to elevate one or more applications for presentation to the user 102 of the client device 104. Alternatively or additionally, in some implementations, targeted advertising may be provided to the user 102 based on the behavioral data 120 determined from the behavioral analysis results. Thus, according to some implementations, the feature of the computer service that is modified may be either a marketplace catalog service or an advertising targeting service. Further, the feature of the computer service may be modified only with respect to the user 102 of the client device corresponding to the received usage data, or the feature of the computer service may be modified with respect to a group of users including the client device user, such as group of friends, a buddy list, a social network group, or other group of which the user 102 is a member.

Additionally, in some implementations, the computer service may be modified by surfacing or elevating one or more identified applications in the computer service. For example, when an individual user accesses the computer service, the computer service may access the individual user's behavioral data in the computer service data store. With respect to the individual user, an application store provided by the computer service might access the user's behavioral data and recommend a particular application to the individual user based on the most recent behavioral analysis results. Alternatively or additionally, the application store may surface a particular application by placing the application in a top ranked position as a result of a search conducted by the user by taking into consideration, at least in part, the behavioral data for that user. For example, the surfacing might include displaying an identifier of at least one of the identified applications in a user interface, such as in response to a search by a user or the user's friends. Thus, the computer service may surface the identified applications by modifying an application search facility so as to return application search results based, at least in part, on the performed behavioral analysis. The surfacing might also include a direct notification or recommendation of at least one of the identified applications in a user interface.

Additionally, in some implementations, the modifying the at least one feature of the computer service may include providing targeted advertising to the user 102 of the client device based at least in part on the performed behavioral analysis. For example, in exchange for subscribing to the computer service, the user may agree to receive advertising. As another example, users may be provided with incentives to share behavioral data, such as by receiving free or reduced-price applications. Thus, the computer service may determine whether the received usage data qualifies for an incentive, and when the received usage data is determined to qualify for an incentive, the at least one feature of the computer service may be modified to provide the incentive.

### Example Process Including Location Data

FIG. 3 is a flow diagram of an example process 300 for modifying a feature of a computer service based on behavior data and location data according to some implementations herein. For discussion purposes, the process 300 is described with reference to the operational architecture 100 of FIG. 1, and may be performed by one or more computing devices that implement the computer service 116. However, other frameworks, devices, systems and environments may also implement this process.

At block 302, usage data relating to an application executed on a client device is received. For example, computer service 116 may receive usage data 114 from client device 104. The usage data 114 may relate directly or indirectly to the use of one or more applications 106 that are executed on the client device. Further, usage data 114 may include location data that indicates a location of the client device 104 at the time that one or more features of an application were used. For example, suppose that user 102 uses a sports information application to look up statistics of a particular football player. Further, suppose that the user's location is identified as being at a football stadium of the particular football player's team. This location information may be included with the usage data 114 provided to the computer service.

At block 304, behavioral analysis is performed on the received usage data to identify at least one behavioral trend. For example, behavior analysis component 118 may be implemented by the computer service 116, and can analyze the received usage data 114 for detecting one or more behavioral trends of the user 102 of the client device 104. In this example, a behavioral trend might include using the sports information application to research football player statistics and statistics for the particular football player.

At block 306, location data corresponding to the usage data received for the application is determined. For example, the analysis component 118 may receive and identify global positioning system (GPS) data that is included with the usage data 114. Furthermore, as mentioned above, if the client device 104 does not have an active location detection system (e.g., the GPS is turned off or does not have a GPS), other information for determining an approximate location may be included with the usage data 114. For example, the usage data 114 may include information regarding nearby cell towers, nearby Wi-Fi access points, and the like. The analysis component 118 may then determine the approximate location of the client device corresponding to the collected usage data. Thus in this example, the analysis component may determine that the user was in the football stadium when the user used the sports information application to research the football player statistics.

At block 308, at least one feature of the computer service may be modified based on the location information and at least some of the behavioral analysis. For example, the computer service may be modified by transmitting a notification identifying one or more applications to a client device subscribing to the notification. Thus, the computer service 116 may use of the location information and the behavioral analysis results to elevate one or more applications for presentation to the user 102 of the client device 104 and/or to the friends of the user 102. Further, in some implementations, the computer service may transmit a notification to a client device in response to the determining that the client device is currently proximate to a location corresponding to the location data. For example, with the permission of user 102, when a friend of the user 102 is determined to be located at the football stadium, the friend might receive a message from the computer service 116 indicating that one or more friends used the sports information application while at the football stadium. Alternatively or additionally, in some implementations, targeted advertising may be provided to a user based on the location data and the behavioral analysis results. For example, the user might receive an invitation to a special event regarding the particular football player or team to be held at the football stadium. Furthermore, the computer service may surface at least one of the identified applications by displaying an identifier of at least one of the identified applications in a user interface of a client device. For instance, while the user 102 is still at the football stadium, the computer service 116 may send the user a notification or an invitation to try out one or more other applications that other users use more often at the football stadium or at other football stadiums. Alternatively, based on knowledge that the user often goes to the football stadium, the computer service may adjust rankings of search results to surface a particular application, such as the sports information application. Thus, the surfacing of an identified application may be performed by modifying an application search facility to return application search results based on at least some of the performed behavioral analysis including the location data. Furthermore, upon determining a location of a user, the computer service may directly transmit a notification identifying an application currently being used by other users who are currently in a location proximate to the received user location data. Additionally, or alternatively, the computer service may transmit a notification regarding an application often used or most often used by other users when in a location proximate to the received user location data. For example, the user may receive a notification that one or more of the user's friends used a particular application in a particular way when at the identified location.

### Example Hardware Environment

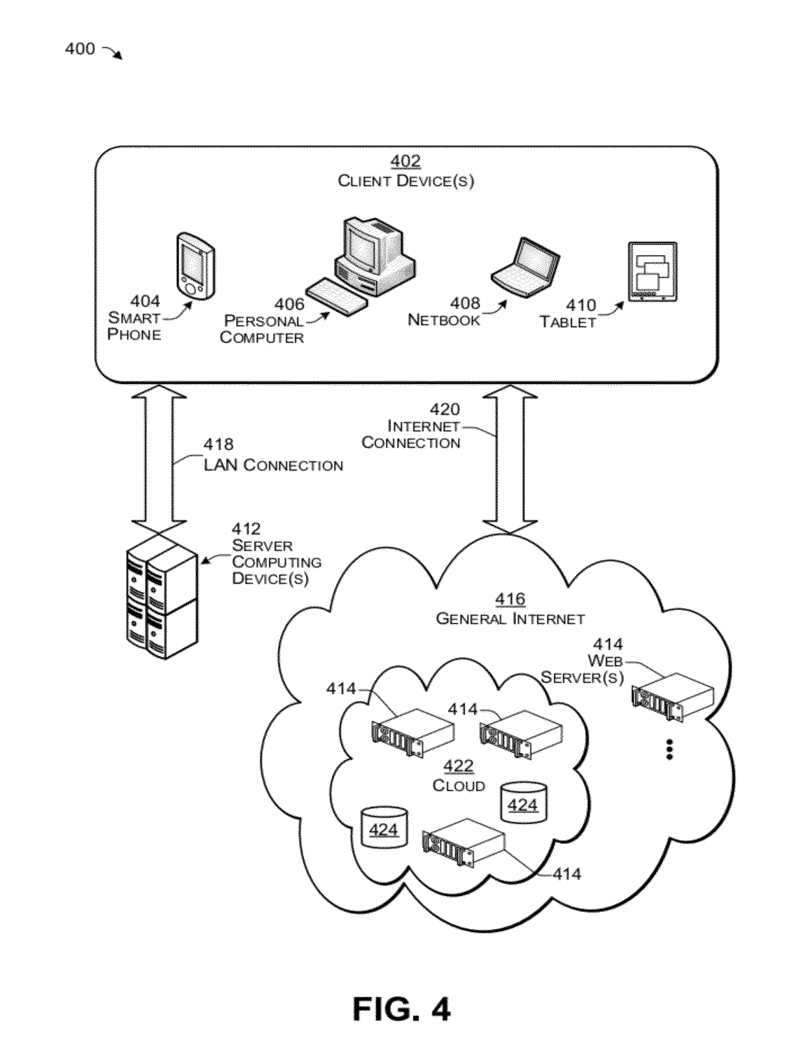

FIG. 4 illustrates an example hardware environment 400 for providing behavior-based computer services according to some implementations. The client side tracking framework 108 described above is capable of being hosted on a wide range of client devices 402. Client devices 402 may be any client that runs applications including, but not limited to a smart phone 404, a personal computer (“PC”) 406, a notebook or netbook 408, an ebook reader or tablet PC 410, or other suitable computing device. As an example, PC 406 may include any device of the standard PC architecture, or may include alternative personal computers such as the Macintosh® from Apple® Computer, or workstations including but not limited to UNIX® workstations. Client devices 402 may correspond to client devices 104, 126 discussed above with reference to FIG. 1.

The client side tracking framework 108 active on the client device 402 may access a computer service hosted on one or more local server computing devices 412 or hosted on one or more web-based server computing devices 414 on the general Internet 416. If a client device 402 accesses a local server computing device 420 on a local area network (“LAN”), client device 402 may connect via any number of LAN connectivity configurations 418. At the physical layer this may include Ethernet® or Wi-Fi. At the network/session/transport layer this may include connectivity via the Transmission Control Protocol/Internet Protocol (“TCP/IP”) or other protocol. If the client device 402 accesses the computer service on the Internet through an Internet connection 420, the client device 402 may connect via standard Internet protocols including TCP/IP for the network/session/transport layer and Hypertext Transfer Protocol (“HTTP”) at the application layer. Additionally, in implementations in which client devices 402 do not have network communication capability, the client devices 402 may provide data to the computer service computing devices or other devices via various other techniques for transferring data, such as by transferring memory cards (e.g., SD memory cards) or thumb drives between devices, or through a wired connectivity such as a universal serial bus (USB) connection.

Server computing devices 412 and web-based server computing devices 414 that serve as the computer service computing devices may be based on a standard PC architecture, or on a mainframe. If accessing the general Internet 430, an independently hosted web server 414 may be accessed that hosts application server software. Example application server software includes Internet Information Server™ (“IIS”) from Microsoft® Corporation or Apache Web Server, an open source application server. Server computing devices 412 and/or web server computing devices 414 may also access one or more database servers (not shown) hosting a database. Example databases include, Microsoft SQL Server® and Oracle®. In this way the behavior-based computer service may run on both 2-tier and 3-tier platforms.

Alternatively or additionally, behavior-based computer service infrastructure may be hosted on a cloud computing service 444. Cloud computing service 444 contains a large number of web-based server computing devices 414 and other computing assets 424, potentially in geographically disparate locations. The servers 414 and computing assets 424 in the cloud 422 may be disaggregated into their constituent CPUs, memory, long term storage, and other component computing assets. Accordingly, various components discussed herein, when hosted on cloud computing service 424, may have both centralized and distributed data storage on the cloud, accessible via a data access API such as Open Database Connectivity (“ODBC”) or ADO.Net™ from Microsoft® Corporation. Further, behavior-based computer services may be hosted on computing assets in the cloud computing service 424 corresponding to one or more application servers.

### Example Architecture for a Computer Service

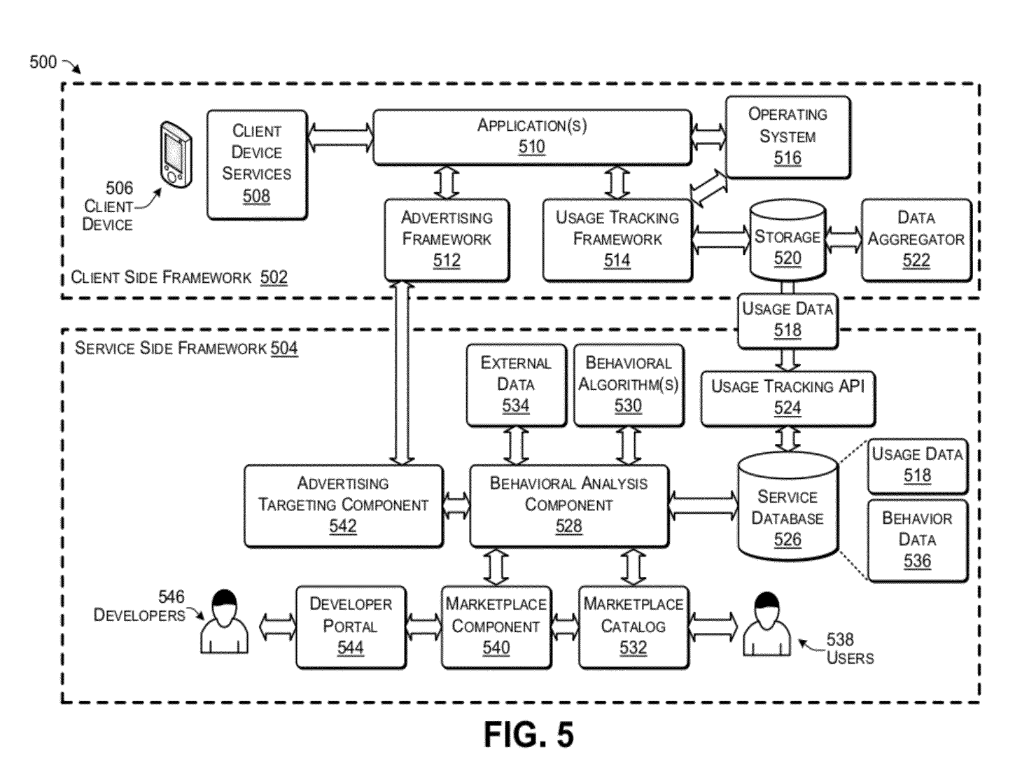

FIG. 5 expands the architecture of FIG. 1 and provides an example block diagram of an architecture 500 for implementing a behavior-based computer service. Architecture 500 may include a client side framework 502 and a service side framework 504. Client side framework 502 may be executed using a client device 506 that may correspond to the client devices 104, 126 of FIG. 1 and client devices 402 of FIG. 4. As discussed above, a user of client device 506 may configure client device 506 to run client side framework 502 to monitor application and/or operating system usage. The user of client device 506 is provided with the opportunity to opt in to using the client side framework 502, and may subsequently opt out of using the client side framework 502 as desired, such that the client side framework 502 does not monitor application or operating system usage. Furthermore, as a client device 506 may potentially have multiple different users, and a user of a client device may potentially use multiple client devices 506, the client side framework 502 may be configured to request login of a particular user before becoming operational, so that an opt-in by one user does not necessarily opt-in all users of a client device 506.

Client side framework 502 may implement client device services 508 for tracking usage data and providing information and/or advertising to the user of the client device. Client side framework 502 may include one or more applications 510 installed on client device 506. Client side framework 502 may also include several sub-frameworks, such as an advertising framework 512, and a usage tracking framework 514. In some implementations, tracking framework 514 may correspond to the tracking framework 108 described above with reference to FIG. 1. For example, usage tracking framework 514 may include one or more software modules that track an action of an application 510 or an operating system 516 of client device 506. This may be performed in several way including, but not limited to trampoline functions, journaling hooks, and application-monitoring APIs (application programming interfaces) exposed by the operating system 516. Examples of such monitoring APIs include, but are not limited to Event Tracing for Windows® (ETW) and Windows Monitoring Interface (WMI) in the Microsoft Windows® operating system. Usage tracking framework 514 may use these, or similar facilities to track application behavioral usage data 518 and place the usage data 518 into a local storage 520.

The tracked behavioral usage data 518 may include, but is not limited to, the identity of the user; the identity of the application function or operating system function being tracked; and the context of the application function or operating system function. The usage data may further include other parameter values associated with the context or the tracked application or operating system action. For example, if a user were to enter text into a text box, an associated parameter value might include the entered text; a context value might include the window title of the form; and an application identity might include the executable name of a web browser. By way of another example, if an operating system action is initiated to switch from a text editor to a browser, the associated parameter values might include the executable names of the text editor and of the browser; a context value might include the name of the active window in the text browser; and the application identity might include the executable name of the operating system. Thus, as used in the claims herein, the term “application” is considered to include an operating system of the client device. Further, various other context information, as discussed above, may also be collected by the usage tracking framework 514 and included in the usage data 518. For example, such context data may include other applications currently running or frozen in the background, applications recently used, location data, time of day, calendar information, social network status information, whether the client device is stationary or in motion, and the like.

Once captured, application usage data 518 may be locally stored, for example in the local storage 520. Local storage 520 may come in any number of forms including, but not limited to, cache memory, local hard drives, local solid state mass storage, or the like. Furthermore, the local storage 520 need not be a temporary cache, but optionally may be a long-term persistent file.

After storage, the stored application usage data 518 may be aggregated. As mentioned above, the usage data 518 may be aggregated and transferred as a batch periodically to the service side framework 504, or may be transferred in real time or near real time, as the usage data 518 is collected, and aggregated at the service side framework 504. In some implementations, a data aggregator 522 may apply aggregation directives on how to extract desired behavioral data from the initially captured application usage data 518. For example an aggregation directive may direct the data aggregator 522 to identify all instances in the initial application usage data 518 where a user switched from a text editor to a web browser. Another example of an aggregation directive might be to identify all instances where hotkeys were used in a text editor. Upon identification of the instances as directed by the aggregation directive, the data aggregator 522 may upload the aggregated usage data 518 to the service side framework 504. The upload action may be done affirmatively by the data aggregator 522, or alternatively done upon receiving a request from the service side framework 504. Accordingly, the data aggregator 522 may support both push and pull protocols.

In another implementation, the data aggregator 522 need not identify all instances of a particular application behavioral usage. For example, where an application 510 is programmed to affirmatively access the usage tracking framework 514, the application may apply additional logic to select particular instances of application behavioral usage for the data aggregator 522 to track. Data aggregator 522 may make use of a data template which specifies the application usage data 518 and aggregation directives. The data template is discussed in further detail in co-pending U.S. patent application Ser. No. ______, Attorney Docket No. MS1-5029US, to Bruno et al., filed on an even date herewith, entitled “Improving Discoverability Using Behavioral Data.” Alternatively, an application 510 on the client device 506 may affirmatively store application usage data by programmatically invoking the data aggregator 522 via an API.

In FIG. 5, data aggregator 522 is shown as executing on the client device 506. However, in alternative implementations, the data aggregator 522 may execute partially or fully on a server.

The client side framework 502 may also comprise additional frameworks including, but not limited to the advertising framework 512. Such additional framework may make use of the application usage data 518 as aggregated according to aggregation directives by the data aggregator 522 and service side sources. For example, advertising framework 512 might make use of aggregated usage data 518 to select and place advertising for display on the client device 506. In the case in which an application 510 is a game, articles for in play purchase may be selected based at least in part on the aggregated application usage data 518. Similarly, advertisements provided during use of a browser may be based at least in part on the aggregated application usage data 518. The advertising framework 512 may also provide additional application tracking facilities including click through tracking and purchase tracking. Applications 510 may affirmatively invoke the advertising framework 512 programmatically via an API. Other additional frameworks (not shown), such as a framework to enable custom features in applications or a framework to customize the look and feel of the client device 506 may also make decisions based at least in part on the aggregated application usage data. Similarly, such additional frameworks may invoke the data aggregator 522 programmatically via an API.

The service side framework 504 of FIG. 5 may include a usage tracking API 524 that receives usage data 518 from the client side framework 502. In the illustrated example, the usage data 518 may be aggregated by data aggregator 522 before being transferred to the service side framework 504. However in other implementations, the data aggregator may be located on the service side, and the usage data may be aggregated after being received by the usage tracking API 524. The usage tracking API 524 may store the usage data 518 and a service database 526. In some implementations, service database 526 may be in the form of one or more server hard drives or other computer-readable media which store application usage data 518 uploaded by the data aggregator 522 of one or more client devices 506. The service database 526 may be implemented as files in a file system, as a relational database, or alternatively as an application specific persistent file, such as a memory-mapped file or a persistence file in a custom binary format.

Service side framework 504 may include a behavioral analysis component 528 that executes one or more behavioral algorithms 530 that may be applied to data aggregated in the service database 526. Behavioral algorithms 530 may also access data in a marketplace catalog 532 and/or other external data 534 to obtain pricing and ranking data for applications. Behavioral algorithms 530 may include, for example, algorithms that seek correlations between one set of behaviors and another set of behaviors or between one set of behaviors and external data, such as rankings within marketplace catalog 532 or, by way of another example, algorithms that detect increasing or decreasing trends in correlations. The behavioral algorithms 530 may also persist results and analyses as behavior data 536 in service database 526 for use by multiple computer services.

Additionally, the behavior analysis component 528 may aggregate the behavior data 536 of multiple different users for determining additional trends and conclusions. For example, when the user has provided permission for the user's data to be aggregated (e.g., anonymously) with the data of other users, the behavior analysis component 528 may invoke one or more of the behavioral algorithms to perform an aggregation function for determining additional behavioral data from the behavioral data 536. Thus, the collected behavior data may be aggregated by the behavior analysis component 528 across a plurality of users. Further, the behavior data of a plurality of users may be aggregated across one or more applications for determining useful behavioral information with respect to particular applications.

Behavior analysis component 528 may either programmatically invoke the behavioral algorithms 530 or may access behavior data 536 results persisted by the behavioral algorithms 530 on service database 526. The behavior analysis component 528 may be exposed to users 538 through a marketplace component 540 and/or an advertising targeting component 542. In some implementations, marketplace component 540 includes, but is not limited to, a pricing recommendation feature and a trending and recommendation feature. Thus marketplace component 540 is able to provide a pricing service, and a trending and application recommendation service.

To perform pricing recommendation the marketplace component 540 may determine correlations between application behavioral data 536 stored in service database 526 and the price that potential application purchasers are willing to pay for a particular application. The marketplace component 540 may recommend a range of prices based on findings of the behavioral analysis component 528. Alternatively, the marketplace component 540 may calculate a price curve showing how pricing may evolve over time. The marketplace component 540 may potentially identify marketplace events, such as an application being featured as most downloaded in a marketplace catalog, or being ranked with five stars out of five, and provide suitable pricing recommendations in correlation with such circumstances. The marketplace component 540 may also provide other marketing options such as bundling an application with other applications.

The marketplace component 540 may also perform a trending and recommendation function to identify correlations between behaviors and data in the marketplace catalog 532. For example, the marketplace component 540 may be configured to change the marketplace catalog 532, specifically by creating a special section of applications a particular user might consider. Thus, the marketplace component 540 may identify recommendations based on behavioral correlations. Further, the marketplace component 540 can also affirmatively change one or more features of a computer service by changing the marketplace catalog 532 based on behavioral correlations gleaned from the behavior data 536.

The advertising targeting component 540 can provide recommendations on how to maximize advertising revenue based on behavioral data 536. For example, the advertising targeting component 540 may search for correlations between users that have the same behavior and the click through rates for advertising. Where there is a strong correlation, the advertising targeting component 542 may invoke the advertising framework 512 on the client side framework 502 to place advertising based on the correlations. The advertising targeting component 542 may consider multiple parameters such as length of time for advertising, length of exposure, placement within an application, cost of placement, and cost of click through. Advertising recommendations may then be exposed via the advertising framework 512.

The marketplace component 540 may also include a developer portal 544 as an access mechanism for software developers 546. Thus, through the developer portal 544, developers 546 may access aggregated behavioral data related to particular applications, such as their own applications or those of competitors. For example, the marketplace component 540 may determine that a particular set of users tweet after purchasing concert tickets, and that those users also tend to use a particular social networking game. The marketplace component 540 can provide product planning recommendations and specifically may recommend to developers 546 that additional social networking games similar to the correlated game be developed. Further, the marketplace component may indicate to developers 546 particular features of their applications that are most often used, how and when their applications or particular features are used, which features are not used, and the like.

Marketplace catalog 532 and developer portal 544 provide access to users 538, such as application purchasers, and developers 546, such as application product planners, respectively. Marketplace catalog 532 and developer portal 544 may be software modules that not only access computer services offered by the service side framework 504, but may also combine results. For example, based on the behavioral analysis, the developer portal 544 may combine pricing, advertising and marketplace catalog modifications all into a comprehensive strategy to achieve a certain revenue result. Similarly, based on the behavioral analysis, the marketplace catalog 532 may have both advertisements placed in the marketplace catalog 532 providing a coupon discount code for an application, and at the same time the marketplace catalog 532 may be modified to bundle the application with another application. Strategies on the client 506 may also be combined with strategies on the marketplace catalog 532. For example, advertisements for a new version of an application appearing on marketplace catalog 532 may be combined with in application purchase opportunities on a client device 506 as exposed via the advertising framework 512.

As an illustrative example, suppose that a first user is running an independently developed twitter application on a client device 506 that displays advertisements. As the first user uses the application to send out tweets, keywords are extracted from the tweets by the usage tracking framework 514 on the client device and provided to the local storage 520. These keywords may be passed through to the service side framework 504 and received by a server computing device, as discussed above, which performs the behavioral analysis using the one or more behavioral algorithms 530. Behavioral algorithm 530 may synch the keywords against a cloud service and the cloud service may learn about the first user's interest or the context of the first user's actions within the application as behavior data 536. The behavior data 536 may then be applied by advertising targeting component 542, which leverages the keywords or interests obtained from the first user's behavior data 536 and produces targeted advertisements. The targeted advertisements are provided to the advertising framework 512 on the client device 506, and are thereby generated within the application. For example, suppose that the first user tweets about a rock star sighted while the user was walking down Hollywood Boulevard. The service side framework may determine suitable advertisements to be provided to the first user, such as advertisements for concert tickets to the rock star's concert or advertisements for local Hollywood attractions. Furthermore, as usage of the particular application increases across the user community, behavioral changes can be introduced into the marketplace catalog 532 as a result of the behavior data determined by the service side framework.

Example scenarios for access to application behavioral computer services for application purchasers via a behavior-aware marketplace catalog 532 include both explicit and implicit capabilities. A user 538, as an application purchaser, may explicitly search for applications in the marketplace catalog 532 by including behavioral terms as part of the search criteria. The marketplace catalog 532 may in turn access the behavioral data for the user, or may access behavioral data aggregated for a class of users of which the particular user is a member, and modify its behavior or a particular feature of its service to suit the particular user based on the behavioral data 536. For example, if a user 538 is known to use Twitter right after purchasing movie tickets, the marketplace catalog 532 may display a window of “Applications You Might Like” where the displayed applications are selected from applications commonly downloaded by other users with similar behaviors.

Similarly, application product planners or developers 546 may retrieve behavioral data 536 from the developer portal 544 to identify features for future versions of applications or to identify opportunities for new applications. The developer portal 544 may offer recommendations on how to position the application in marketing including, but not limited to, recommendations for pricing, advertising, and tagging to increase marketplace catalog ranking and visibility. By way of another example, application product planners or developers 546 may use information from the developer portal 544 to obtain recommendations on how to modify a currently available application's marketplace catalog ranking and visibility.

### Example Process for a Computer Service

FIG. 6 is a flow diagram of an example process 600 for a computer service according to some implementations herein. For discussion purposes, the process 600 is described with reference to the architecture 500 of FIG. 5, although other architectures, frameworks, devices, systems and environments may implement this process.

At block 602, usage data relating to a client device user is received. For example, a service computing device (e.g., one of computing devices 412, 414) may receive usage data 518 from a client device (e.g., client devices 104, 402, 506) with respect to the use of one or more applications on the client device.

At block 604, behavioral analysis is performed on the usage data. For example, the service computing device may implement behavioral analysis component 528 which executes one or more behavioral algorithms 530 to perform behavioral analysis on the usage data 518 to yield behavior data 536.

At block 606, one or more features of the computer service may be modified based on the analysis. For example, based on the behavior data 536 the computer service may modify one or more features such as a marketplace catalog or advertisements provided to the client device. The one or more features may be modified for an individual, for a group, or for all users, depending on the permission is granted by the users in which the behavioral data was obtained.

At block 608, with respect to the individual, the one or more features modified may include user-specific changes for an identified individual that corresponds to particular behavior data that is the basis for the modification of the one or more features. For example, based on the behavior data it may be determined that a particular user likes a particular sports team. Accordingly, the modification to the computer service may include providing advertisements to the user related to the particular sports team.

At block 610, with respect to the group, it is first determined for which data the users have granted permission for aggregation. For example, the users may permit aggregation of data from some applications but not from others for presenting behavior data to their friends, or other groups.

At block 612, the computer service aggregates the behavior data for the group where permitted.

At block 614, with respect to all users, where permission has been granted the computer service may aggregate data from all users (e.g., anonymously), and may use this aggregated behavior data to determine additional behavioral information.

At block 616, the computer service determines the scope of changes to be made based on the behavioral data obtained from the analysis results. For example, as mentioned above, changes may be made to features of the computer service on an individual basis, on a group basis, or for all users.

At block 618, with respect to the individual, the computer service may modify particular features such as recommendations made to the individual for purchasing particular applications, or advertisements provided to the individual that are personalized based on the behavior data provided by the individual. For example, following the modifications one or more particular applications may be surfaced to the user based on the behavior data for the individual.

At block 620, with respect to the group, the computer service may modify particular features of the computer service such as a portal for a particular group, e.g., the marketplace catalog. For example, when an identified member of the particular group accesses the marketplace catalog, the group member may be presented with a version of the marketplace catalog customized according to behavioral characteristics determined for the particular group based on the behavioral data 536 aggregated for the group. For example, following the modifications, one or more particular applications may be surfaced to members of the group based on the behavioral data aggregated for the group.

At block 622, with respect to all users, the computer service may modify particular features of the computer service such as modifying a public portal e.g., the marketplace catalog. For example, based on the behavioral data aggregated for all users, the computer service may modify the marketplace catalog, such as by changing rankings of particular applications, surfacing particular applications, or the like.

### Example Client Device and Environment

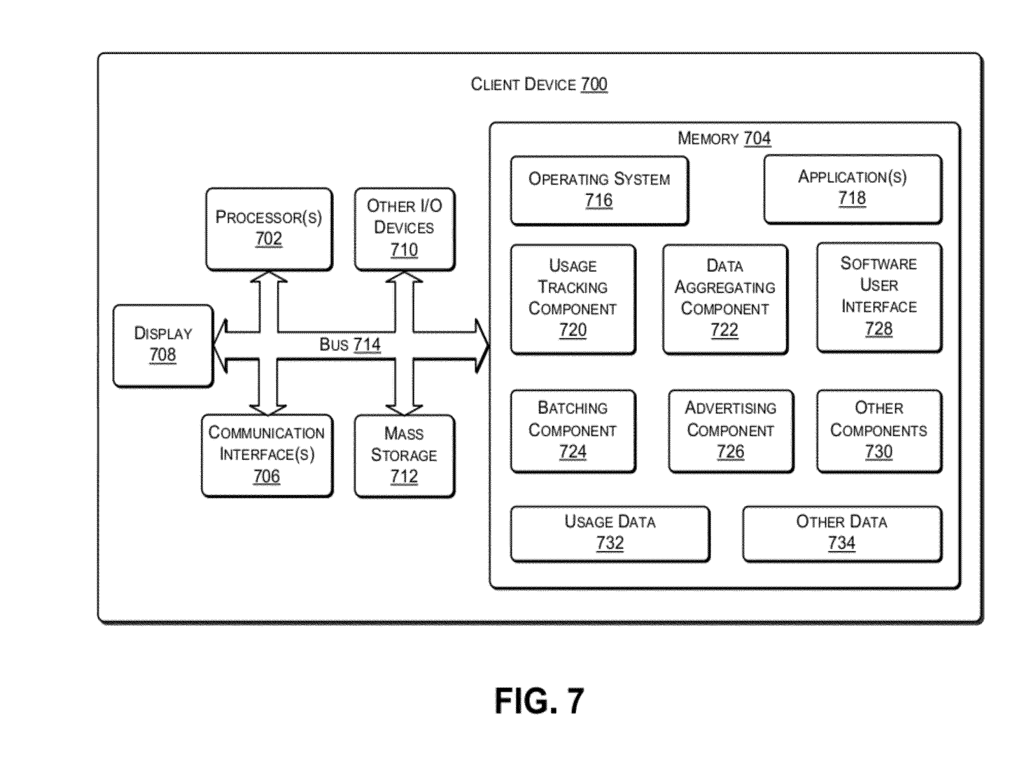

FIG. 7 illustrates select components of an example client device 700 that can be used to implement the client side frameworks, components and functions described herein. In some implementations, client device 700 may correspond to the client devices 104, 126, 402-410 and 506 described above. The client device 700 may include at least one processor 702, a memory 704, communication interfaces 706, a display device 708, other input/output (I/O) devices 710, and one or more mass storage devices 712, able to communicate with each other, such as via a system bus 714 or other suitable connection.

The processor 702 may be a single processing unit or a number of processing units, all of which may include single or multiple computing units or multiple cores. The processor 702 can be implemented as one or more microprocessors, microcomputers, microcontrollers, digital signal processors, central processing units, state machines, logic circuitries, and/or any devices that manipulate signals based on operational instructions. Among other capabilities, the processor 702 can be configured to fetch and execute processor-executable instructions stored in the memory 704, mass storage devices 712, or other computer-readable storage media.

The client device 700 can also include one or more communication interfaces 706 for exchanging data with other devices, such as via a network, direct connection, or the like, as discussed above. The communication interfaces 706 can facilitate communications within a wide variety of networks and protocol types, including wired networks (e.g., LAN, cable, etc.) and wireless networks (e.g., WLAN, cellular, satellite, etc.), the Internet, and the like. Communication interfaces 706 can also provide communication with external storage (not shown), such as a storage array, network attached storage, storage area network, or the like.

A display 708, such as a liquid crystal display, or other suitable display type, may be included in some implementations for displaying information to users. Other I/O devices 710 may be devices that receive various inputs from a user and provide various outputs to the user, and can include a keyboard, keypad, a remote controller, a mouse, audio input/output devices, and so forth. In some implementations, display 708 may be touch sensitive, and may also serve as an input device, as well as an output device. For example, display 708 may provide a virtual keyboard, keypad, or other virtual controls.

Memory 704 and mass storage devices 712 are examples of computer-readable media for storing instructions which are executed by the processor 702 to perform the various functions described above. For example, memory 704 may generally include both volatile memory and non-volatile memory (e.g., RAM, ROM, or the like). Further, mass storage devices 712 may generally include hard disk drives, solid-state drives, removable media, including external and removable drives, memory cards, Flash memory, floppy disks, optical disks (e.g., CD, DVD), a storage array, a network attached storage, a storage area network, or the like. Both memory 704 and mass storage devices 712 may be non-transitory computer storage media, and may collectively be referred to as memory or computer-readable media herein.

Memory 704 and/or mass storage 712 are capable of storing computer-readable, processor-executable instructions as computer program code that can be executed by the processor 702 as a particular machine configured for carrying out the operations and functions described in the implementations herein. For example, memory 704 may include modules and components for tracking usage according to the implementations herein. In the illustrated example, memory 704 includes an operating system 716 and one or more applications 718. Memory 704 also includes a usage tracking component 720 that may implement the tracking frameworks 108, 514 described above. Memory 704 also includes a data aggregation component 722 that may serve as the data aggregator 522 described above. Additionally memory 704 includes a batching component 724 that may periodically send batches of usage data to the computer service. Further, memory 704 includes an advertising component 726 than may implement the advertising framework 512 described above. Memory 704 may also include a software user interface 728 to enable the user to interact with the client device 700 and the various components. For example, the user may use the software user interface 728 to configure settings and preferences for the usage tracking component, such as to specify for which applications to share usage data. Memory 704 may also include one or more other components 730, such as drivers, communication software, or the like. Memory 704 may also include usage data 732 collected by the usage tracking component 720, as described above. Memory 704 may further include other data 720, such as data used by the applications 718 or operating system 716.

### Example Service Computing Device

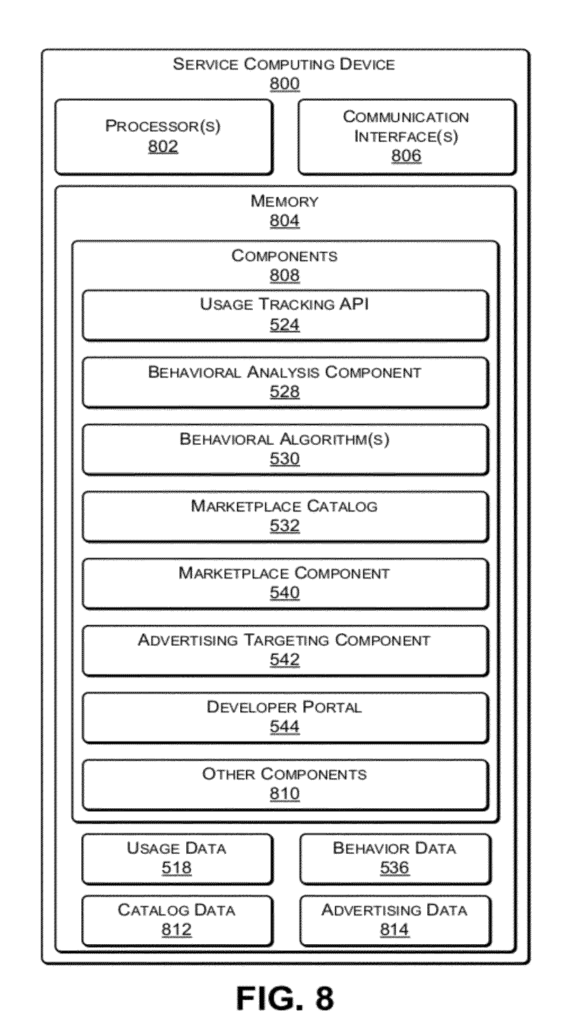

FIG. 8 illustrates select components of an example service computing device 800 that can be used to implement the service side frameworks, components and functions described herein. In some implementations, service computing device 800 may correspond to the server computing devices 412, 414 and other computing resources 424 described above. The client device 800 may include at least one processor 802, a memory 804 and communication interfaces 806.

The processor 802 may be a single processing unit or a number of processing units, all of which may include single or multiple computing units or multiple cores. The processor 802 can be implemented as one or more microprocessors, microcomputers, microcontrollers, digital signal processors, central processing units, state machines, logic circuitries, and/or any devices that manipulate signals based on operational instructions. Among other capabilities, the processor 802 can be configured to fetch and execute processor-executable instructions stored in the memory 804 or other computer-readable storage media.

The service computing device 800 can also include one or more communication interfaces 806 for exchanging data with other devices, such as via a network, direct connection, or the like, as discussed above. The communication interfaces 806 can facilitate communications within a wide variety of networks and protocol types, including wired networks (e.g., LAN, cable, etc.) and wireless networks (e.g., WLAN, cellular, satellite, etc.), the Internet, and the like. Communication interfaces 806 can also provide communication with external storage (not shown), such as a hard disk drive, a storage array, network attached storage, storage area network, or the like.

Memory 804 is an example of computer-readable media for storing instructions which are executed by the processor 802 to perform the various functions described above. For example, memory 804 may generally include both volatile memory and non-volatile memory (e.g., RAM, ROM, or the like). Further, memory 804 may also include mass storage devices, such as hard disk drives, solid-state drives, removable media, including external and removable drives, memory cards, Flash memory, floppy disks, optical disks (e.g., CD, DVD), a storage array, a network attached storage, a storage area network, or the like. Memory 804 may be non-transitory computer storage media, and may be referred to as memory or computer-readable media herein.

Memory 804 is capable of storing computer-readable, processor-executable instructions as computer program code that can be executed by the processor 802 as a particular machine configured for carrying out the operations and functions described in the implementations herein. For example, memory 804 may include modules and components for performing behavioral analysis and modifying a feature of a computer service according to the implementations herein. In the illustrated example, memory 804 includes a plurality of components 808, including the usage tracking API 524, the behavioral analysis component 528, the one or more behavioral algorithm(s) 530, the marketplace catalog 532, the marketplace component 540, the advertising targeting component 542, and the developer portal 544, as described above. Memory 804 may also include one or more other components 810, such as an operating system, drivers, communication software, or the like. Memory 804 may also include usage data 518, and behavior data 536, as described above. Memory 804 may further include other data 820, such as catalog data 812, and/or advertising data 814.

Further, while service computing device 800 is illustrated in FIG. 8 as a single computing device, in other implementations, service computing device 800 may be a plurality of different computing devices, storage devices, and the like, located at the same or at separate locations. For example, in the case of a cloud implementation, a plurality of different computing devices may implement various different portions of the components and services described herein. Accordingly, implementations herein are not limited to the configurations illustrated.

Additionally, although illustrated in FIGS. 7 and 8 as being stored in memory 704 of client device 700 and memory 804 of service computing device 800, the various components, data structures and modules described herein, or portions thereof, may be implemented using any form of computer-readable media that is accessible by client device 700 or service computing device 800, respectively. Computer-readable media includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
under control of one or more processors configured with executable instructions,
receiving, by a computer service, usage data relating to an application executed on a client device;
performing behavioral analysis on the received usage data to identify at least one behavioral trend associated with the application; and
modifying at least one feature of the computer service based on at least some of the behavioral analysis performed on the usage data.

2. The method according to claim 1, wherein the computer service is either a marketplace catalog service or an advertising targeting service.

3. The method according to claim 1, wherein the at least one feature of the computer service is modified only with respect to the client device user corresponding to the received usage data.

4. The method according to claim 1, wherein the at least one feature of the computer service is modified with respect to a group of a plurality of users including the client device user corresponding to the received usage data.

5. The method according to claim 1, further comprising identifying applications to surface in the computer service based, at least in part, on the performed behavioral analysis, wherein the at least one feature of the computer service is modified by surfacing the identified applications in the computer service by influencing an application search facility to return application search results based, at least in part, on the performed behavioral analysis.

6. The method according to claim 5, wherein the computer service surfaces the identified applications by at least one of:
displaying an identifier of at least one of the identified applications in a user interface; or
recommending at least one of the identified applications in a user interface.

7. The method according to claim 1, further comprising:
receiving usage data relating to the application from a plurality of users of a plurality of client devices; and
aggregating the usage data for the application from the plurality of users to identify one or more behavioral trends related to the application.

8. The method according to claim 1, wherein the received usage data comprises
an identity of a user of the client device;
the identity of an application function executed on the client device; and
a context in which the application function is executed.

9. The method according to claim 1, wherein the received usage data is associated with a group of a plurality of users that share an affiliation, the method further comprising sharing the received usage data with at least one of the associated users of the group.

10. The method according to claim 1, further comprising:
notifying users of incentives to share behavioral data;
determining whether the received usage data qualifies for an incentive; and
when the received usage data is determined to qualify for the incentive, further modifying the at least one feature of the computer service to provide the incentive.

11. The method according to claim 1, wherein modifying the at least one feature of the computer service includes providing targeted advertising to the client device user corresponding to the received usage data, the advertising based, at least in part, on the performed behavioral analysis.

12. One or more computer-readable media having executable instructions stored thereon that, when executed by one or more processors, implement operations comprising:
receiving usage data relating to an application executed on a client device;
performing behavioral analysis on the received usage data for determining at least one behavioral trend associated with the application;
determining location data corresponding to the usage data received for the application executed on the client device; and
identifying one or more applications to surface in a computer service based on the received location data and at least some of the performed behavioral analysis.

13. The one or more computer-readable media according to claim 12, wherein the determining the location data further comprises determining the location data from at least one of a cellular tower identification or a wireless access point identification received with the usage data.

14. The one or more computer-readable media according to claim 12, the operations further comprising transmitting a notification identifying the one or more applications to a client device subscribing to the notification.

15. The one or more computer-readable media according to claim 14, the operations further comprising transmitting the notification to the client device in response to the determining that the client device is currently proximate to a location corresponding to the location data.

16. The one or more computer-readable media according to claim 12, the operations further comprising at least one of:
surfacing at least one of the identified applications by displaying an identifier of at least one of the identified applications in a user interface; or
surfacing at least one of the identified applications by modifying an application search facility to return application search results based on at least some of the performed behavioral analysis.

17. The one or more computer-readable media according to claim 12, wherein the application is a first application, the operations further comprising:
receiving an identification of a second application running on the client device concurrently with the first application; and
identifying one or more applications to surface in the computer service based on the received location data, at least some of the performed behavioral analysis, and the identification of the second application running on the client device.

18. The one or more computer-readable media according to claim 12, the operations further comprising transmitting a notification identifying the one or more applications, the notification including at least one of the following:
an application used by users who are currently in a location proximate to the received user location data; and
an application used by users when in a location proximate to the received user location data.

19. A client device comprising:
a processor;
a data storage, communicatively coupled to the processor, to store usage data;
a tracking component, executed on the processor, to monitor user usage with respect to an application, and to store the usage data on the data storage with corresponding context information;
a batching component to transfer the usage data and context information to a computer service; and
a display operatively coupled to the processor to display user-specific information received from the computer service based on behavioral analysis of the usage data and context information.

20. The client device according to claim 19, wherein the user-specific information is at least one of:
a recommended application surfaced based on the behavioral analysis; or
a targeted advertisement that is targeted to the user based on the behavioral analysis.
